(19) United States
(12) Patent Application Publication
(10) Pub. No.: US 2011/0220681 A1
(43) Pub. Date: Sep. 15, 2011

(54) APPARATUS AND METHOD FOR RECIRCULATING STILLWATER AND/OR SEMI-CARBONATED WATER

(76) Inventor: Reinhard Paul, Dillenburg (DE)

(21) Appl. No.: 13/048,658

(22) Filed: Mar. 15, 2011

Related U.S. Application Data
(60) Provisional application No. 61/314,040, filed on Mar. 15, 2010.

(51) Int. Cl. B67D 7/74; B67D 7/80

(52) U.S. Cl. 222/129.1; 222/146.6; 222/1

(57) ABSTRACT

A device for recirculating stillwater in a beverage dispensing system includes a cooling device and a conduit having the stillwater recirculated therein. At least a portion of the conduit is in thermal communication with the cooling device.

### CROSS REFERENCE TO RELATED PATENT APPLICATIONS

This application claims the benefit of U.S. Provisional Application No. 61/314,040, filed Mar. 15, 2010. U.S. Provisional Application No. 61/314,040, filed Mar. 15, 2010 is hereby incorporated herein by reference in its entirety.

### BACKGROUND

1. Field of the Disclosure

The present disclosure relates generally to dispensing stillwater. More particularly, the present disclosure relates to an apparatus and method for recirculating stillwater prior to dispensing the stillwater from a beverage dispensing system.

2. Description of Related Art

A beverage dispenser mixes stillwater, semi-carbonated water or carbonated water with a syrup to form a beverage. The beverage dispenser dispenses the beverage into a container so that the beverage may be served to a consumer. Water is carbonated by a remote soda circuit carbonator. The remote soda circuit carbonator also typically delivers stillwater to the beverage dispenser for non-carbonated drinks. Remote soda circuit carbonators are currently chilling premix beverages including stillwater, carbonated water and syrup that are maintained in insulated tubing prior to dispensing the premixed beverage to a consumer allowing the stillwater, which is not in thermal communication with a cooling device while within the insulated tubing, to increase in temperature, as only the carbonated water is continuously chilled within the insulated tubing. These non-carbonated or semi-carbonated postmix beverages that are formed using the stillwater within the insulated tube that is not in thermal communication with a cooling device are far too often out of specification or above a predetermined temperature, for example, greater than 40 degrees Fahrenheit (4.4 degrees Celsius), especially, after a long period of time between dispensing the non-carbonated or semi-carbonated postmix beverages where a portion of the stillwater is maintained in the insulated tubing for an undesirably long period of time.

Prior attempts to continuously chill stillwater prior to dispensing the stillwater from the beverage dispensers used a separate vessel to chill and dispense the stillwater due to pressure needs. Such a vessel undesirably increases cost as well as increases size of the beverage dispenser systems.

Accordingly, it has been determined by the present disclosure, there is a need for a system and method for recirculating stillwater continuously until the stillwater flows to a beverage dispenser to be dispensed to a consumer.

### SUMMARY

A device for recirculating stillwater in a beverage dispensing system is provided that includes a cooling device and a conduit having the stillwater recirculated therein. At least a portion of the conduit is in thermal communication with the cooling device.

A method of recirculating stillwater is also provided that includes recirculating the stillwater in a conduit and cooling the stillwater when a portion of the stillwater is recirculated into thermal communication with a cooling device.

The above-described and other advantages and features of the present disclosure will be appreciated and understood by those skilled in the art from the following detailed description, drawings, and appended claims.

### BRIEF DESCRIPTION OF THE DRAWINGS

FIG. 1 is a side cross-sectional schematic view of an exemplary embodiment of a stillwater recirculating system according to the present disclosure.

FIG. 2 is a partial side cross-sectional schematic view of the stillwater recirculating system of FIG. 1 connected to a pumped-still-water-facility system.

### DETAILED DESCRIPTION

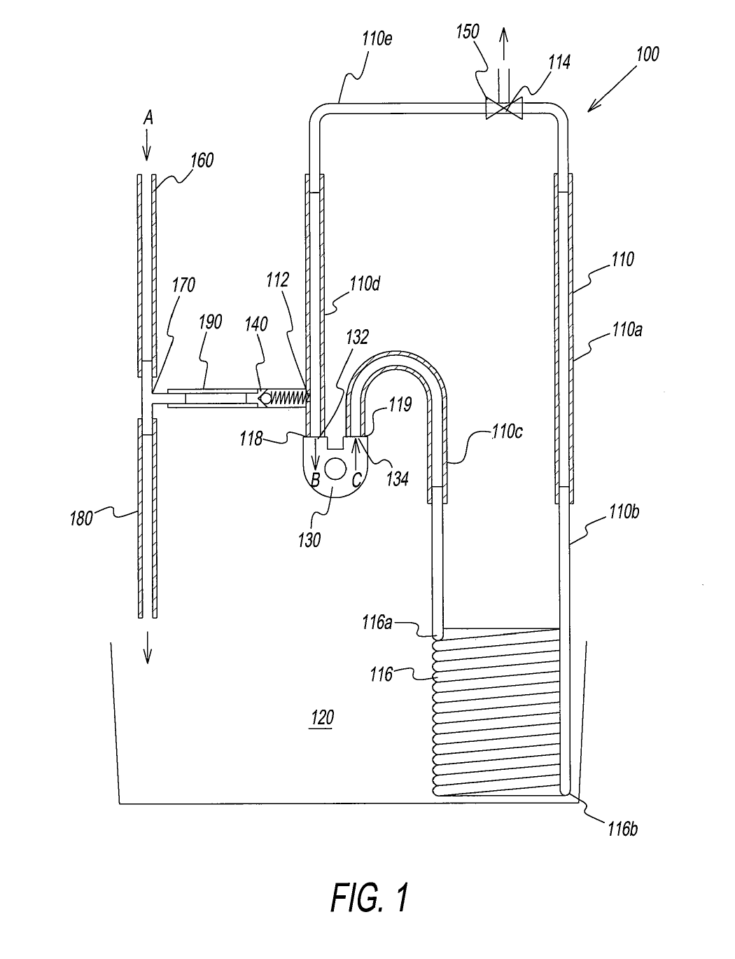

Referring to the drawings and in particular to FIG. 1, an exemplary embodiment of a stillwater recirculating system according to the present disclosure is generally referred to by reference numeral 100. Stillwater is defined herein as liquid that is substantially free of carbonation, for example, water free of carbonation. Alternatively, stillwater recirculating system 100 may be used with any other liquid, for example, semi-carbonated water.

System 100 has a conduit 110 that forms a loop or continuous flow path so that the stillwater may be recirculated, or circulated more than once, through conduit 110. Conduit 110 may be a continuous conduit or made of separate pieces 110a, 110b, 110c, 110d, and 110e that are connected. Conduit 110 is made of a material that is food grade. Conduit 110 has a diameter, for example, from about 1/16 inch to ½ inch. The diameter of the whole circuit 110 could be different or identical.

A portion of conduit 110 is in thermal communication with a cooling device 120 so that stillwater in conduit 110 is also in thermal communication with cooling device 120 at least when the stillwater is flowing through the portion of conduit 110 in thermal communication with cooling device 120. Cooling device 120 may be any cooling device, such as, for example, a refrigeration circuit, fan, ice bath, plate heat exchanger, beer cooler etc. FIG. 1 shows cooling device 120 as a holding container for a cooling medium, for example, ice and/or chilled water. The portion of conduit 110 that is in thermal communication with cooling device 120 is submerged within the cooling medium. In order to increase the portion of conduit 110 in thermal communication with cooling device 120, a portion of conduit 110 may form stacked connected loops or coils 116 of conduit 110. Coils 116 are sized to be submerged within the cooling medium within the holding container of cooling device 120. The stillwater within conduit 110 may flow within coils 116 from coil inlet 116a to coil outlet 116b. Coils 116 are made of material that allows thermal communication between the cooling device and the stillwater within coils 116, for example, coils 116 may be made of food grade material of good heat conductivity, such as, for example, stainless steel or copper. A portion of conduit 110 not submerged in the cooling medium or in thermal communication with cooling device 120 can be insulated to reduce an increase in temperature of the stillwater within conduit 110 not submerged in the cooling medium or in thermal communication therewith.

Conduit 110 is connected to a pump 130. Conduit 110 may be separated so that an end 118 of conduit 110 connects to a pump inlet 132 and another end 119 of conduit 110 connects to a pump outlet 134 so that fluid within conduit 110 flows into pump inlet 132 from end 118 and out of pump 130 through pump outlet 134 into end 119. Pump 130 may include an impeller that rotates to move fluid. Other examples of pump 130 includes rotary vane pumps of the type that are used in any soda recirculation system to reduce a number of replacement parts used by service technicians. Pump 130 is of a food grade material. End 118 may be connected to pump inlet 132 and end 119 may be connected to pump outlet 134.

Conduit 110 has an inlet 112 and an outlet 114. Conduit 110 may include an inlet valve 140 at inlet 112 and an outlet valve 150 at outlet 114. Inlet valve 140 is a non-return valve allowing flow in one direction into conduit 110. Inlet valve 140 has an open position allowing the stillwater to pass therethrough and a closed position preventing the stillwater from passing therethrough. Inlet valve 140 may be a check valve to selectively allow the stillwater to flow into conduit 110 in the open position. Outlet valve 150 has an open position allowing the stillwater to pass therethrough and a closed position preventing the stillwater from passing therethrough. Conduit 110 forms a closed loop when inlet valve 140 is in the closed position and outlet valve 150 is in the closed position.

Outlet valve 150 connects the stillwater within conduit 110 to a beverage dispenser that dispenses the stillwater for a beverage. Outlet valve 150 is in close proximity to a device that mixes and dispenses a beverage into a container to be served to a consumer. The stillwater flows to the beverage dispenser that mixes the stillwater, semi-carbonated water or carbonated water with a syrup to form a beverage. Outlet valve 150 selectively allows the stillwater to flow out of conduit 110 in the open position. Outlet valve 150 may be a postmix valve. The beverage dispenser may have existing postmix valves. The postmix valve has two inlets. A first inlet selectively dispenses the stillwater from conduit 110 in the open position. A second inlet selectively dispenses the syrup from a storage device. The syrup and the stillwater are mixed in the beverage dispenser upon being dispensed from the first inlet and the second inlet. The first inlet and the second inlet can be activated mechanically, electrically via solenoids, or, in some applications, even microprocessor controlled, where an amount of the stillwater and/or an amount of the syrup is measured in order to inject appropriate amounts. In case of semi-carbonated drinks, a mixing device is positioned between conduit 110 and the first inlet to mix carbonated water and stillwater to a predetermined ratio to form the semi-carbonated water.

System 100 may be connected to a stillwater source through inlet valve 140. The stillwater source is an existing water supply line within a building that supplies stillwater. However, other sources of stillwater may also be connected to system 100. The stillwater source may be connected to a fluid conduit 160. Fluid conduit 160 may also supply stillwater to another assembly of a beverage dispenser, such as, for example, a carbonator, through a connector 170 to a conduit 180. Connector 170 may be a T-piece connector as shown in FIG. 1. Connector 170 connects fluid conduit 160 to system 100 by conduit 190. Conduit 190 is connected to system 100 through inlet valve 140.

In use, stillwater enters fluid conduit 160 from an existing water supply line. The existing water supply line has a pressure generating a flow of the stillwater to connector 170, as shown by arrow A. A portion of stillwater flows to conduit 180 and a portion of stillwater flows to conduit 190. An amount of stillwater is permitted to enter system 100 through inlet valve 140 to conduit 110. Inlet valve 140 may be a non-return-valve that maintains a closed position and opens to an open position from the closed position only when pressure within conduit 110 decreases below a predetermined pressure in a supply line. A pressure generated by pump 130 creates a flow of stillwater through conduit 110 to pump inlet 132, as shown by arrow B, and flows out of pump 130 through pump outlet 134, as shown by arrow C, back into conduit 110 to coil inlet 116a. The stillwater flows through coils 116, and is cooled by cooling device 120 that is in thermal communication with coils 116, to coil outlet 116b. The stillwater flows through conduit 110 from coil outlet 116b to outlet 114. Outlet valve 150 may permit the stillwater to exit conduit 110 through outlet valve 150 when outlet valve 150 is in the open position. When outlet valve 150 is in the closed position, the stillwater flows through conduit 110 to pump 130. The stillwater is recirculated as provided herein until a portion of the stillwater is dispensed through outlet valve 150. Each time the stillwater is recirculated through coils 116, the stillwater is cooled by cooling device 120.

It has been found by the present disclosure that system 100 being pumped in a continuous circuit, or recirculated, cools the stillwater so that the stillwater flows from system 100 to a dispenser that mixes the syrup therein at a temperature that is less than a predetermined desired temperature of about 40 degrees Fahrenheit (4.4 degrees Celsius), especially after long periods of non-dispense. Further, it has been found by the present disclosure that system 100 may cool other liquid in a beverage dispenser connected thereto, for example, the syrup that is mixed with the stillwater to form a beverage that is dispensed. The syrup may not be cooled allowing a temperature of the syrup to increase, for example, to room temperature or about 72 degrees, when there is a period of time between dispensing the beverage including the stillwater. System 100 reduces the temperature of the syrup so that the dispensed beverage including the syrup and the stillwater is at a temperature that is reduced as compared to a beverage dispensed from a system without system 100.

System 100 may have cooling device 120 remote from outlet valve 150. Due to the recirculation of the stillwater in conduit 110 into contact with cooling device 120 that is remote from outlet valve 150, the stillwater is maintained at the predetermined temperature prior to mix and dispense of a beverage including the stillwater. For example, outlet valve 150 may be about fifty feet from cooling device 120 so that outlet valve 150 is included in the beverage dispenser used by a server or consumer to dispense a beverage in a restaurant, and cooling device 120 is in the remote location away from the consumer or server. Accordingly, system 100 allows beverages including the stillwater to be dispensed from a beverage dispenser at a temperature that is as cold as drinks dispensed from the beverage dispenser mixed with carbonated water. In addition, system 100 may be easily connected to an existing carbonated water dispensing system by connecting inlet valve 140 at a location to receive stillwater. Alternatively, system 100 may be integrated with a carbonated water dispensing system during manufacturing thereof.

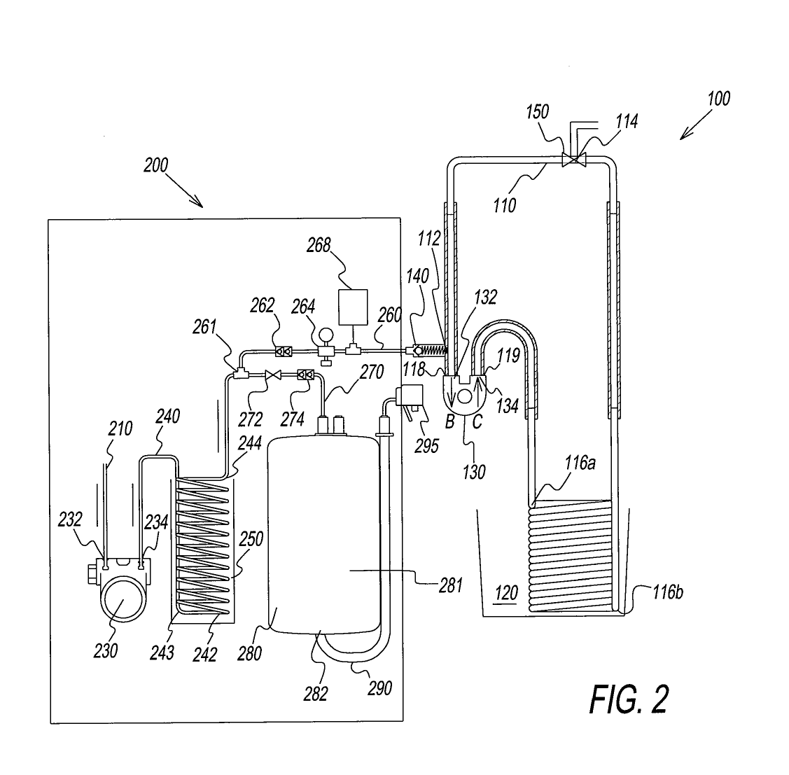

Referring now to FIG. 2, system 100 is connected to a pump-still-water-facility system 200. System 100 is connected to system 200 through inlet valve 140. System 200 is connected to a stillwater source so that stillwater flows into a conduit 210. The fluid source is an existing water supply line within a building that supplies stillwater. However, other sources of stillwater may also be connected to conduit 210.

Conduit 210 is connected to an inlet 232 of a carbonator pump 230. Carbonator pump 230 may have a controller to activate and deactivate carbonator pump 230. Alternatively, carbonator pump 230 may have a controller to increase and/or decrease a pressure generated thereby. When activated, carbonator pump 230 generates a pressure to direct flow of the stillwater in system 100 and system 200. Carbonator pump 230 has an outlet 234 connected to a portion of conduit 240.

Conduit 240 is in thermal communication with a cooling device 250 so that stillwater therein is also in thermal communication with cooling device 250. Cooling device 250 may be any cooling device, such as, for example, a refrigeration circuit, fan, ice bath, plate heat exchanger, beer cooler etc. FIG. 2 shows cooling device 250 as a holding container for a cooling medium, for example, ice and/or chilled water, having the portion of conduit 240 in thermal communication with cooling device 250 submerged within the cooling medium. The portion of conduit 240 in thermal communication with a cooling device 250 may have stacked connected loops or coils 242 to increase a length of conduit 240 in thermal communication with a cooling device 250. Coils 160 and coils 242 are shown in FIG. 2 as being in thermal communication with separate cooling devices 120, 250, however, coils 160 and coils 242 may be cooled by a single cooling device, for example, a single holding container holding ice and/or chilled water with coils 160 and coils 242 submerged therein.

Conduit 240 is connected to a connector 261. Connector 261 is a crosspiece that connects conduit 240 with a conduit 260 and a conduit 270. Alternatively, connector 261 may be placed in coil 242 in order to decrease length and decrease an amount of space of system 200. Conduit 270 connects to a carbonator 280 through a controller valve 272, for example, a solenoid valve, and a non-return valve 274. Positions of controller valve 272 and non-return valve 274 can also be exchanged if this is made desirable by layout of the installation. Carbonator 280 has a level electrode in a carbonator vessel 281 that detects an amount of liquid, or waterline, therein. Carbonator 280 is connected to a connection conduit 290 via a carbonator outlet 282 through carbonator vessel 281 that connects to a beverage dispenser that mixes stillwater, semi-carbonated water or carbonated water with a syrup to form a beverage by a connector 295.

Conduit 260 is connected to a non-return valve 262, a pressure reducer 264, and a pressure switch 268. Non-return valve 262 prevents the stillwater from flowing toward connector 261 after passing through non-return valve 262. Pressure reducer 264 reduces a pressure in the stillwater generated by carbonator pump 230 so that the stillwater is at a pressure that may be dispensed through the beverage dispenser without spray. Pressure reducer 264 may be any pressure reducer known in the art. Pressure switch 268 detects the pressure of the stillwater that passes therethrough. Pressure switch 268 may be any pressure switch used for water known in the art. For example, pressure switch 268 may be a silicone made diaphragm that switches a microswitch on or off depending on the pressure. Once the stillwater flows through inlet valve 140, the stillwater enters system 100 as described above.

In use, stillwater in system 200 enters conduit 210 from an existing building's water source. A pressure generated by the building's existing water source has a pressure, for example, about 2.0 bar to 2.5 bar, that generates a flow of the stillwater through conduit 210. The stillwater enters carbonator pump 230 through pump inlet 232. Carbonator pump 230 generates a pressure that increases pressure of the flow of the stillwater, for example, to about 11 bar. The flow of stillwater exits pump outlet 234 to flow through conduit 240. The stillwater flows through coil inlet 243 of conduit 240 and through coils 242 into thermal communication with cooling device 250 to cool the stillwater. The stillwater exits coils through coil outlet 244 and flows through conduit 240 to connector 261. Connector 261 directs a portion of the flow of the stillwater to conduit 260 and a portion of the flow of the stillwater to conduit 270.

The flow of the stillwater flows past nonreturn valve 262, pressure reducer 264, and pressure switch 268 in conduit 260 from connector 261. The water supply source can vary in pressure that varies the pressure of the stillwater in system 100 and system 200. The stillwater flows past nonreturn valve 262, so that the stillwater may not flow in a direction toward connector 261 thereafter. Pressure reducer 264 can reduce the pressure of the flow of the stillwater to a predetermined pressure if the flow of the stillwater is above the predetermined pressure. For example, the predetermined pressure may be about 4.4 bars that is the factory setting, but depending on the total length of conduit 260 and conduit 110, it may be necessary to modify the predetermined pressure at a point of installation of the pressure reducer in order for a pressure at outlet valve 150 to be within an operation range of the postmix valve, for example, about 1 to about 4 bars.

Pressure switch 268 detects the pressure of the flow of the stillwater in conduit 260 that passes pressure switch 268. When pressure switch 268 detects a pressure that is below a predetermined level, for example, about 0.5 bars below about 4 bar, then a controller of carbonator pump 230 increases pressure, for example to 120-150 pounds per square inch (psi), to increase the flow of the stillwater. Similarly, when pressure switch 268 detects a pressure that is above the predetermined level, for example, about 0.5 bars above about 4 bars, then a controller of carbonator pump 230 deactivates carbonator pump 230 to create a decrease in the flow of the stillwater. Alternatively, a controller of carbonator pump 230 increases and decreases pressure of carbonator pump 230 to create an increase or decrease in the flow of the stillwater. The stillwater within conduit 260 flows past pressure switch 268 to inlet valve 140. Once the stillwater flows through inlet valve 140, the stillwater enters conduit 110 as described above.

The flow of the stillwater flows past controller valve 272 and non-return valve 274 in conduit 270 from connector 261 into carbonator 280. While the pressure is being increased by carbonator pump 230 due to the pressure of the flow of the stillwater detected by pressure switch 268, the electrode of carbonator 280 may indicate to a controller of controller valve 272 that the liquid within carbonator vessel 281 is below a predetermined level so that the controller of controller valve 272 opens controller valve 272 supplying the stillwater through non-return valve 274 in conduit 270 to carbonator 280. Alternatively, if the pressure is not increased by carbonator pump 230 due to the pressure of the flow of the stillwater detected by pressure switch 268, the controller of carbonator pump 230 may increase the pressure generated by carbonator pump 230 while controller valve 272 opens to direct the stillwater into carbonator 280 in response to the electrode indicating to the controller of carbonator pump 230 that the liquid within carbonator vessel 281 is below the predetermined level. Therefore, the controller of carbonator pump 230 may also switch carbonator pump 230 on and off via demand of carbonated water in carbonator vessel 281. Pressure reducer 264 reduces the pressure of the flow of the stillwater to the predetermined pressure in conduit 260 when the controller of carbonator pump 230 increases the pressure generated by carbonator pump 230 in response to the electrode indicating the liquid within carbonator vessel 281 is below the predetermined level.

Carbonator 280 carbonates the stillwater to form carbonated water. Carbonator 280 dissolves carbon dioxide in the stillwater to form carbonated water. Carbonator 280 has a connection conduit 290 that connects to a beverage dispenser by a connector 295.

Pressure at carbonator outlet 282 is maintained at a substantially constant pressure by a constant pressure of carbon dioxide applied to carbonator vessel 281. Varying pressure of the stillwater from the water supply source can vary the pressure of the stillwater that flows out of system 100 to the beverage dispenser and may not always be sufficient in terms of maintaining a predetermined mixture of syrup and the stillwater in a dispensed beverage. As discovered by the present disclosure, increasing and/or decreasing the flow of the stillwater by carbonator pump 230 regulates the flow of the stillwater within system 100 and ensures proper mixture of syrup and the stillwater in a dispensed beverage. Carbonator pump 230 is set, for example, during manufacture of system 200, to a predetermined outlet pressure, for example, of not less than about 10 bars. The predetermined outlet pressure may be out of an operating range of outlet valve 150, for example, the postmix valve. The addition of pressure reducer 264 ensures substantially constant pressure at outlet valve 150.

Pump 130 is shown as a wall mounted pump. The wall mounted pump may be used with systems, for example, systems similar to system 200 that do not initially include system 100. Alternatively, pump 130 may be an integral part of system 200.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A device for recirculating stillwater in a beverage dispensing system comprising:
a cooling device; and
a conduit having the stillwater recirculated therein, at least a portion of said conduit being in thermal communication with said cooling device.

2. The device of claim 1, wherein at least a portion of said conduit or a coiled portion of said conduit is disposed within said cooling device.

3. The device of claim 1, wherein said conduit has an inlet having an inlet valve and an outlet having an outlet valve, wherein said inlet valve is a non-return-valve that maintains a closed position and opens to an open position from said closed position only when pressure within said conduit decreases below a predetermined pressure in a supply line, and wherein said outlet valve has an open position allowing the stillwater to pass therethrough and a closed position preventing the stillwater from passing therethrough.

4. The device of claim 3, wherein said conduit forms a closed loop when said inlet valve is in said closed position and said outlet valve is in said closed position.

5. The device of claim 4, wherein said conduit receives the stillwater through said inlet when said inlet is in said open position.

6. The device of claim 3, further comprising a pump connected to said conduit that recirculates the stillwater within said closed loop of said conduit into thermal communication with said cooling device to cool the stillwater.

7. The device of claim 3, wherein the stillwater exits said closed loop of said conduit through said outlet when said outlet valve is in said open position.

8. The device of claim 7, further comprising an insulated tube that connects said conduit to a beverage dispenser that mixes the stillwater with a syrup to form a beverage.

9. The device of claim 1, further comprising a pump-still-water-facility system.

10. A method of recirculating stillwater comprising:
recirculating the stillwater in a conduit; and
cooling the stillwater when a portion of the stillwater is recirculated into thermal communication with a cooling device.

11. The method of claim 10, wherein at least a portion of said conduit or a coiled portion of said conduit is disposed within said cooling device.

12. The method of claim 10, wherein said conduit has an inlet having an inlet valve and an outlet having an outlet valve, wherein said inlet valve is a non-return-valve that maintains a closed position and opens to an open position from said closed position only when pressure within said conduit decreases below a predetermined pressure in a supply line, and wherein said outlet valve has an open position allowing the stillwater to pass therethrough and a closed position preventing the stillwater from passing therethrough.

13. The method of claim 12, further comprising closing said inlet valve and said outlet valve to form a closed loop in said conduit.

14. The method of claim 13, further comprising opening said inlet so that said conduit receives the stillwater therethrough.

15. The method of claim 13, wherein said conduit is connected to a pump that recirculates the stillwater within said closed loop of said conduit into thermal communication with said cooling device to cool the stillwater.

16. The method of claim 13, further comprising opening said outlet so that the stillwater exits said closed loop of said conduit through said outlet.

17. The method of claim 16, wherein said outlet valve is connected to an insulated tube that connects said conduit to a beverage dispenser that mixes the stillwater with a syrup to form a beverage.

18. The method of claim 10, wherein said conduit is connected to a pump-still-water-facility system.
